(19) United States
(12) Patent Application Publication
(10) Pub. No.: US 2010/0167792 A1
(43) Pub. Date: Jul. 1, 2010

(54) POWER-SAVING METHOD AND ELECTRICAL DEVICE USING THE SAME

(75) Inventors: Xudong Chen, Shanghai (CN); Shih-Kuang Tsai, Shanghai (CN)

Correspondence Address: MCDERMOTT WILL & EMERY LLP, 600 13TH STREET, N.W., WASHINGTON, DC, 20005-3096, US

(73) Assignees: INVENTEC APPLIANCES (SHANGHAI) CO., LTD.; INVENTEC APPLIANCES CORP.

(21) Appl. No.: 12/640,994

(22) Filed: Dec. 17, 2009

(30) Foreign Application Priority Data
Dec. 25, 2008 (CN) 200810207753.4

(51) Int. Cl. H04M 1/00; G06F 1/32

(52) U.S. Cl. 455/566; 713/320; 455/574

(57) ABSTRACT

A power-saving method for an electronic device is provided. The electrical device has a power-saving mode. The method includes detecting a position of the electronic device, and activating the power-saving mode if the detected position is determined to be one of a plurality of pre-determined power-saving positions. A system for performing the method is also provided. The system includes a detection unit for detecting the position of the mobile device, and an operational mode control unit coupled in signal communication with the detection unit. The control unit controls the mobile device to enter one of a power-saving mode and a wake-up mode based on the signals received from the detection unit.

### BACKGROUND

1. Technical Field

The present invention relates generally to power-savings. Specifically, the present invention relates to methods and systems for reducing power consumption through position detection.

2. Discussion of Related Art

With the development of science and technologies, it has become a trend for electrical devices, such as mobile phones, to have multiple functions. Nowadays, it is common that mobile phones can not only make phone calls but also play music, take photos, play games, and so on. However, multifunctional phones generally consume more power than single function phones.

Some methods have been employed for reducing power consumption in electrical devices, such as mobile phones. Such methods may provide specific interface(s) on a mobile phone for deactivating certain functions when not in use. Specifically, the illumination time may be set to the shortest one of several selectable time periods, and the color lights and the vibrating notifications may also be turned off.

Some known power-saving methods include pressing a key to manually enter a power-saving mode; using light sensors or other light sensitive components to control the operation of lighting component(s) such as light-emitting diode (LED); controlling the display of screen and keyboard via control circuits integrated in a mobile phone; and configuring the mobile phone system so that the mobile phone may enter a power-saving mode when the mobile phone is idle for a certain time period.

A mobile phone having a power-saving mode is disclosed in Chinese patent application No. 200510086262.5. The phone includes a key for activating/deactivating a power-saving mode and switching off/on a plurality of communication-unrelated functions of the mobile phone. Specifically, when a user presses the key, a switch turns on/off the power supply to the components performing certain communication-unrelated functions. In this mobile phone, the power-saving mode is manually activated by pressing the key.

Another mobile phone having a power-saving mode is disclosed in Chinese patent No. 02278368.7. This mobile phone uses a light sensitive component to control the output of a lighting circuit on the main board. However, the use of light sensitive component or light sensor increases the manufacture cost, and the function can be realized by the light sensitive component is limited.

In U.S. Pat. No. 6,385,470, a power consumption controlling method is disclosed. A pulse width modulation DC-DC converter is provided in a mobile phone for converting the voltage of the battery to the working voltages of the circuitry in accordance with different requirements. Although this method provides two states of the power consumption, the change of the states is still decided by a user's manual selection of the working modes of the mobile phone (such as active mode and sleep mode). As such, this method can not automatically control the output of electric power.

### BRIEF DESCRIPTION OF THE DRAWINGS

The present invention is described herein below in terms of exemplary embodiments. These embodiments are non-limiting embodiments. These exemplary embodiments are described in detail with reference to the drawings, in which like reference numerals represent similar structures or elements throughout the drawings, and wherein:

FIG. 1 is a flow chart of a process for entering a power-saving mode in accordance with an embodiment of the present invention;

FIG. 2 is a flow chart of a process for activating a wake-up mode in accordance with an embodiment of the present invention; and

FIG. 3 illustrates a block diagram of a system for performing the power-saving method in accordance with an embodiment of the present invention.

### DETAILED DESCRIPTION

An exemplary power-saving method and system applicable to the present invention will be described below. Specifically, the power-saving method may use a position/orientation detector for power-saving in an electrical device.

In an exemplary embodiment described below, the power-saving method is used in a mobile phone, and the position detector is a three-dimensional accelerometer (3D accelerometer). However, it should be understood that the power-saving method may also be applicable to other portable devices, such as hand-held game machines, lap-top computers and personal digital assistants, and/or non-portable devices. It should also be understood that other known position detecting components, such as levelers, may also be used as the position detector in alternative embodiments.

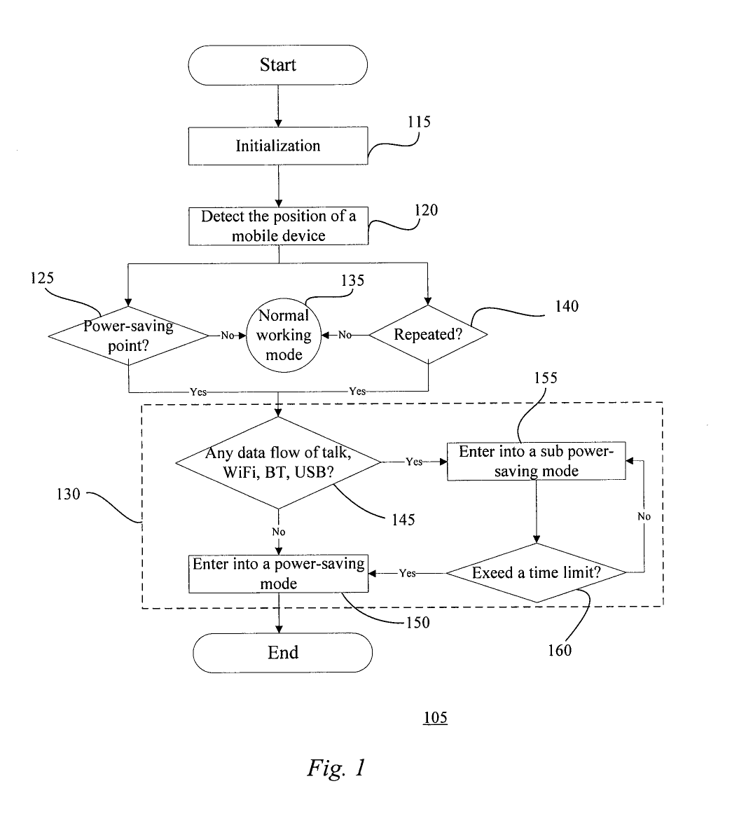

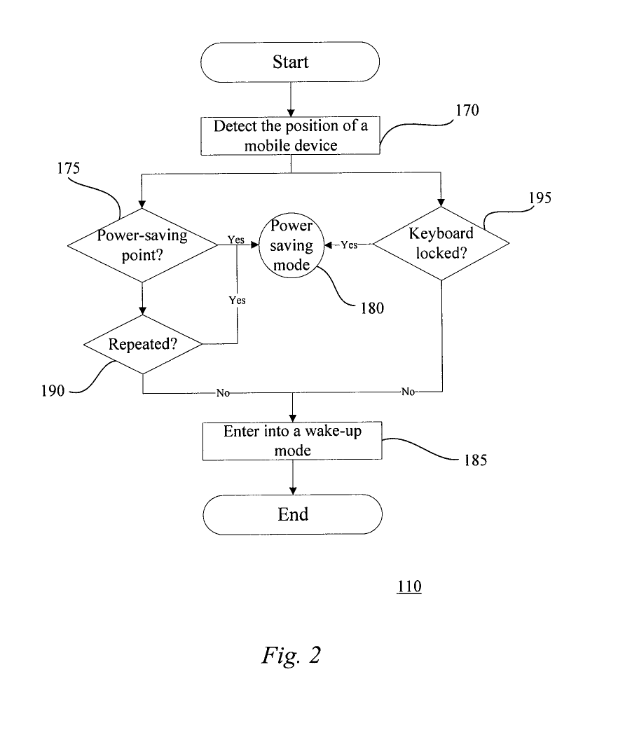

In the exemplary embodiment, the power-saving method includes a process 105 for determining whether to enter a power-saving mode of the mobile phone as illustrated in FIG. 1, and a process 110 for determining whether to activate/enter a wake-up mode of the mobile phone as illustrated in FIG. 2.

FIG. 1 illustrates an exemplary flow chart of the process 105 for determining whether to activate/enter a power-saving mode. It should understood that the process 105 may be periodically performed when the mobile phone is in a normal working mode or a non power-saving mode. In a step 115, the process 105 initializes the 3D accelerometer. Specifically, the 3D accelerometer may be used to detect the positions/orientations of the mobile phone. The step 115 may designate a plurality of pre-determined positions/orientations of the mobile phone as power-saving points.

In the exemplary embodiment, the power-saving points may include several pre-determined positions/orientations of the mobile phone, such as for example, a horizontal position/orientation at which a major plane of the mobile phone is substantially horizontal, a vertical position/orientation at which a shorter side plane is substantially horizontal and a side vertical position/orientation at which a longer side plane is substantial horizontal. In addition, at least one of a position/orientation at which the mobile device is positioned substantially horizontally, a position/orientation at which the mobile device is positioned substantially vertically, and a position/orientation at which a display of the mobile phone is substantially facing downward may also be the power-saving points.

Due to characteristics of the display of the mobile phone, especially when the display is a Liquid Crystal Display (LCD), above mentioned positions/orientations usually is inconvenient for a user to view the content on the LCD. As such, those positions/orientations may be set as power-saving points since the user usually does not look at the LCD when the mobile phone is at one of these positions.

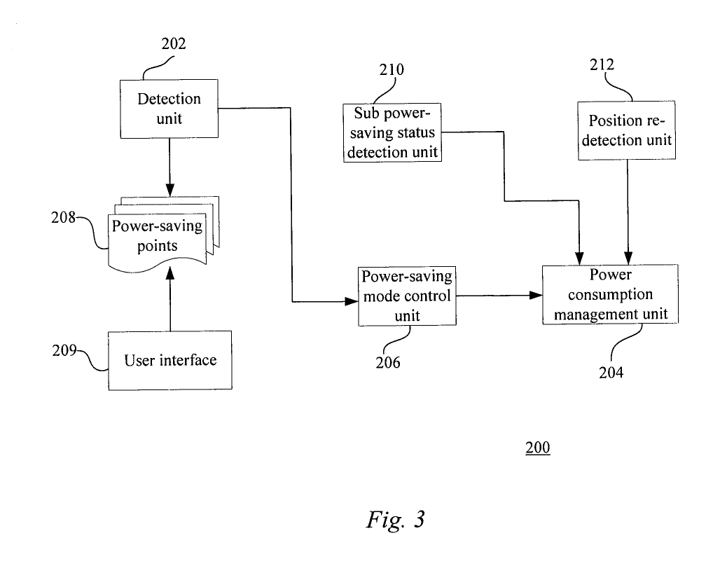

However, it should be understood that, the power-saving points may be set to other suitable positions which are inconvenient for reading. In addition, the power-saving points may be altered/adjusted according to different electrical devices and/or different user habits. It should also be understood that the power-saving points may be several specific positions/orientations and/or several ranges of positions/orientations, and the number of the power-saving points may be increased and decreased. Furthermore, the power-saving points may be pre-stored in a storage of the mobile phone or be manually selected by the user. The pre-stored/selected power-saving points may also be automatically changed/adjusted by the mobile phone, or be manually adjusted/cancelled by the user via a user interface, such as the interface 209 shown in FIG. 3.

In a step 120, the accelerometer detects the real-time position/orientation of the mobile phone. In a step 125, the process 105 compares and determines whether the detected position/orientation is one of the power-saving points. If the detected position/orientation is one of the power-saving points, a power-saving process 130 is performed. If the detected position/orientation is not the power-saving point, the process goes to a step 135 and remains in the normal working mode of the mobile phone.

In a further embodiment, the process 105 may perform a step 140 for determining whether to perform the power-saving process 130 based on the detected positions. The step 140 detects whether the mobile phone is repeatedly moving between a non power-saving position/orientation and a power-saving position/orientation. Specifically, if the process 105 detects that the mobile phone moves back and forth between a non power-saving position/orientation and a power-saving position/orientation within a predetermined time period, a repeated movement/sway is determined. It should be understood that, a repeated movement/sway may also be determined, upon detecting that the mobile phone is moving periodically between two power-saving positions/orientations or moving between two non power-saving positions/orientations.

Upon determining a repeated movement/sway, the power-saving process 130 is performed. Otherwise, the process returns to the step 135 and remains in a normal working mode. It should be understood that, the user may not use certain functions of the mobile phone, such as reading the content displayed on the LCD when the mobile phone is in such a repeated movement/sway. As such, the step 140 facilities temporarily deactivating certain functions of the mobile phone to save power.

In one embodiment, only one of the steps 125 and 140 is performed in the process 105 for determining whether to activating the power-saving process 130. In another embodiment, both the steps 125 and 140 are performed substantially simultaneously. In still another embodiment, the power-saving process 130 is performed when one or both of the steps 125 and 140 generates a request for performing the process 130. Otherwise, the process 105 goes from the step 125 or 140 to the step 135, and the mobile phone remains in the normal working mode. In still another embodiment, the step 140 is performed before the step 125. Specifically, when the step 140 detects a repeated movement/sway, the power-saving process 130 is performed; otherwise the process 105 goes from the step 140 to the step 125. Then the process 105 goes from the step 125 to the step 135 or the process 130 depending whether the power-saving point is detected.

In the power-saving process 130, at first, in a step 145, the process 130 detects whether there is any data transmission, i.e., data flow, in the mobile phone. Specifically, the data transmission may include the data transmission through Wireless Fidelity (WiFi), Bluetooth (BT), and/or Universal Serial Bus (USB), communication data, and/or other wire/wireless data transmission.

If there is no data transmission detected, in a step 150, the mobile phone enters the power-saving mode. Otherwise, in a step 155, the mobile phone enters a sub power-saving mode.

In an exemplary embodiment, in the power-saving mode, the power supply to the display, to the lighting component of the keyboard and the display, and/or to the components for performing the data transmission may be cut off. In another embodiment, rather than turning off the display, certain function associated with the display are still active, such as displaying only an await picture or a clock on the display. Alternatively, the display may be adjusted to the lowest one of several lighting levels in the power-saving mode. As compared with the power-saving mode, in the exemplary sub power-saving mode, the components for performing certain functions not related to display, such as the components for data transmission are still active. As such, in the sub power-saving mode, the data transmission may continue when the mobile phone is positioned at one of the pre-determined power-saving points. In addition, a smaller amount of power is consumed in the power-saving mode than in the sub power-saving mode.

In a further embodiment, in a step 160, the process 130 detects whether a pre-determined time limit is exceeded when the mobile phone is in the sub power-saving mode. If the time limit is exceeded, the process 130 goes to the step 150 and enters the power-saving mode; otherwise the mobile phone remains in the sub power-saving mode. As such, the components for performing the data transmission are deactivated when the time limit is exceeded. Specifically, the time limit may be pre-defined to be long enough for the completion of the data transmission in the sub power-saving mode. In an alternative embodiment, in a step 160, the process 130 periodically detects whether the data transmission is completed. When the data transmission is completed, the process 130 also goes to the step 150 and enters the power-saving mode.

In an exemplary embodiment, when data are transmitted from the mobile phone to some other devices, the user may place the mobile phone at a horizontal plane. If the horizontal position is defined as the power saving point, the power-saving process 130 will be performed. Normally, the mobile phone will directly enter the power-saving mode. However, when the mobile phone is transmitting data, the sub power-saving mode is activated, and the functions unnecessary for the data transmission may be de-activated to save power.

In an exemplary embodiment, the mobile phone may also enter the power-saving mode by pressing a pre-determined key, such as a “Locking” key (not shown) which also locks the keyboard and/or by detecting that the mobile phone is idle for a pre-determined time period. It should be understood that the process 105 may not interfere with other processes for determining whether to enter or to exit the power-saving mode. Specifically, when the mobile phone is the normal working mode or a non power-saving mode, more than one method may be performed independently of each other to determine whether to activate the power-saving mode.

FIG. 2 illustrates an exemplary flow chart of the process 110 for determining whether to activate the wake-up mode. It should understood that the process 110 may be periodically performed when the mobile phone is in the power-saving mode or the sub power-saving mode. Upon detecting that the position/orientation of the mobile phone is changed from the power-saving point to a non power-saving position/orientation, the process 110 activates a non power-saving mode.

First, in a step 170, the process 110 detects the position/orientation of the mobile phone. In a step 175, the process 110 then determines whether the detected position/orientation is one of the power-saving points. If the detected position/orientation is one of the power-saving points, the process goes to a step 180 and remains in the corresponding power-saving mode or the sub power-saving mode. Otherwise, the process 110 may directly go to a step 185 and activate the wake-up mode. By activating an exemplary wake-up mode, the mobile phone exits the power-saving mode or the sub power-saving mode, and resumes the pervious operating mode, such as the normal working mode.

In a further embodiment, the process 110 performs a step 190 when the step 175 determines that the detected position/orientation is not the power-saving point. In an exemplary embodiment, similar to the step 140 (shown in FIG. 1), the step 190 detects a repeated movement/sway, based on the detected position which may be obtained from the step 170. Specifically, the step 190 detects whether the mobile phone is repeatedly moving between a non power-saving position/orientation and a power-saving position/orientation within a predetermined time period. Upon determining the repeated movement/sway, the process goes to the step 180 and remains in the power-saving mode or the sub power-saving mode. Otherwise, the process goes to the step 185 and activates the wake-up mode.

In the illustrated embodiment, the process 110 performs the step 190 between the steps 175 and 185. As such, the mobile phone remains in the power-saving mode even when the mobile phone is swaying and periodically moved to a non power-saving position/orientation. In another embodiment, the process 110 may also perform the step 190 between the steps 170 and 175. As such, when the repeated movement/sway is determined, the mobile phone goes to the step 180 and remains in the power-saving mode. Otherwise, the process 110 goes to the step 175 to determine whether the detected position is the power-saving position.

In still a further embodiment, the process 110 may perform a step 195 after the position is detected at 170. In an exemplary embodiment, the step 195 detects whether the keyboard of the mobile phone is locked. If the keyboard is locked, the mobile phone remains in the power-saving mode or the sub power-saving mode. In another word, the mobile phone is prevented from exiting the power-saving mode through the process 110 when the keyboard is locked. If the keyboard is not locked, the step 195 generates a logic signal, such as a “True” signal for entering/activating the wake-up mode at 185.

In one embodiment, the step 175 and the step 195 are performed substantially simultaneously by two separated operating units or by a single operating unit. The step 185 activates the wake-up mode, only when the process 110 goes through the steps 175 and 190 to generate a signal for activating the wake-up mode, and a logic signal, such as a “True” signal is received from the step 195. In another embodiment, the process 110 performs the step 195 between the steps 170 and 175, the process goes to the step 175 only when the keyboard is not locked. In still another embodiment, the process 110 performs the step 195 between the steps 190 and 185, the process 110 goes to the step 185 only when the keyboard is not locked. In still another embodiment, the process 110 performs the step 195 before the step 170, and the process 110 goes to the step 170 only when the keyboard is not locked.

As described above, upon pressing the “Locking” key, the mobile phone may enter the power-saving mode and the process may lock the keyboard. By performing the step 195 according to one of the above embodiments, the process 110 does not wake up the mobile phone when the power-saving mode or the sub power-saving mode is activated by the “Locking” key. As such, the process 110 for exiting the power-saving mode does not interfere with other power-saving methods. When the power-saving mode is activated by another method, such as using the “Locking” key or the mobile phone being un-operated for certain time, the power-saving mode may be deactivated only through the process designated for this method.

FIG. 3 illustrates a block diagram of an exemplary system 200 for performing the power-saving method described above. In one embodiment, the system is integrated into a mobile phone. It should be understood that, the system 200 may also be applicable to other portable or non-portable electrical devices.

In the illustrated embodiment, the system 200 includes a detection unit 202, a power consumption management unit 204 and a power-saving mode control unit 206. The detection unit 202 detects the positions/orientations of the mobile phone. In an exemplary embodiment, the detection unit 202 is a 3D accelerometer.

The power-saving mode control unit 206 is coupled to and in signal communication with the detection unit 202. The power-saving mode control unit 206 receives the information regarding the detected position/orientation of the mobile phone from the detection unit 202 and determines whether the mobile phone should active a power-saving mode or a wake-up mode. Upon determining to active a power-saving mode or a wake-up mode, the power-saving mode control unit 206 sends control signal to the power consumption management unit 204 for performing corresponding operations.

Specifically, the power-saving mode control unit 206 receives and compares the position information received from the detection unit 202 with the power-saving points stored in a power-saving points database 208. As described above, the power-saving points may be pre-determined or be input/adjusted/selected by the user through a user interface 209, such as a keyboard.

When the mobile phone is in a normal working mode and the information from the detection unit 202 indicates that the mobile phone is at one of the power-saving points, the power-saving mode control unit 206 generates corresponding control signals to the power consumption management unit 204 to control the mobile phone to enter the power-saving mode. Otherwise, the mobile phone remains in the normal working mode. When the mobile phone is in the power-saving mode and the information from the detection unit 202 indicates that the mobile phone is not at one of the power-saving points, the power consumption management unit 204 controls the mobile phone to enter the wake-up mode according to the control information from the power-saving mode control unit 206. Otherwise, the mobile phone remains in the power-saving mode.

The system 200 further includes a sub power-saving status detection unit 210 coupled to the power consumption management unit 204. The unit 210 detects whether the mobile phone is in a sub power-saving mode, and detects how long the mobile phone is in the sub power-saving mode. If the sub power-saving status detection unit 210 detects that there are data transmission in or out of the mobile phone, the unit 210 informs the power consumption management unit 204 to enter the sub power-saving mode when the mobile phone is detected in the power-saving point. If it is detected that the mobile phone is in the sub power-saving mode more than a pre-determined time limit, the unit 210 informs the power consumption management unit 204 the to enter the power-saving mode.

In a further embodiment, the system 200 may also includes a position re-detection unit 212. The position re-detection unit 212 may re-detect the position of the mobile phone after the detection unit 202 has detected and sent detected information to the power consumption management unit 204.

It should be understood that, the system may also include a unit (not shown) for detecting whether the keyboard of the mobile phone is locked when it is in the power-saving mode. If yes, the mobile phone remains in the power-saving mode, otherwise the mobile phone enters the wake-up mode. This unit sends the detected information to the power consumption management unit 204 for determining whether the mobile phone should enter the wake-up mode or not.

The exemplary method, system and mobile phone in accordance with the present invention may provide two kinds of mechanisms: a power-saving double-check mechanism (not shown) corresponding to the re-detection step or the re-detection unit of the mobile phone and the system, and an additional power-saving mechanism (not shown) corresponding to the step of detecting whether the keyboard is locked in the wake-up mode. The power-saving double-check mechanism provides a re-detection function to the system or the mobile phone in case the mobile phone is swaying between a power-saving position and a non power-saving position so as to ensure a correct judgment regarding whether the system or the mobile phone should enter or exit the power-saving mode.

The additional power-saving mechanism is designed to allow appropriate compatibility with relevant original power-saving arrangements of the mobile phone corresponding to possible habits of a user. For instance, a mobile phone may be pre-designed to enter a sleeping mode (i.e., the power-saving mode of the present invention) after locking the keyboard. In this case, if the mobile phone is updated with the system or the method of the present invention, the mobile phone will not automatically enter the wake-up mode if it is detected that the keyboard is locked.

Therefore, by using the exemplary power-saving method, the mobile phone or the system may automatically enter the power-saving mode when it is located at some specific positions, and thus it becomes very convenient to use such mobile phone while reduce power consumption effectively. Moreover, the position detector may also be designed to perform other functions at the same time besides the power-saving function. For example, the accelerometer may be used to monitor whether the mobile phone is dropped so as to trigger corresponding inner protection programs thereof and save relevant data in time.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular methods, steps, units and systems the invention is not to be limited to the particulars disclosed, but rather can be embodied in a wide variety of forms, some of which may be quite different from those of the disclosed embodiments, and extends to all equivalent methods, steps, units and systems, such as are within the scope of the appended claims.

We claim:

1. A power-saving method for an electronic device having a display, comprising:
detecting a position of the electronic device; and
activating a power-saving mode and reducing the power consumption of the display in response to the detected position in one of a plurality of pre-determined power-saving positions.

2. The method as claimed in claim 1, further comprising:
detecting a position of the electronic device in the power-saving mode;
comparing the detected position with the plurality of power-saving positions in the power-saving mode; and
entering a wake-up mode of the electronic device based on the detected position.

3. The method as claimed in claim 2, further comprising:
detecting whether a keyboard of the electronic device is locked; and
entering the wake-up mode based on both the detected position and whether the keyboard is locked.

4. The method as claimed in claim 2, further comprising:
re-detecting the position of the electronic device after said comparing the detected position;
comparing the re-detected position with the plurality of power-saving positions; and
entering the wake-up mode based on the re-detected position.

5. The method as claimed in claim 1, further comprising designating a plurality of positions as the pre-determined power-saving positions, wherein the power-saving positions include at least one of a substantially horizontal position at which a major plane of the electronic device is substantially horizontal, a substantially vertical position at which a shorter side plane of the electronic device is substantially horizontal and a side vertical position at which a longer side plane of the electronic device is substantially horizontal.

6. The method as claimed in claim 1, wherein said activating a power-saving mode further comprising:
detecting data transmission in the electronic device;
entering a sub power-saving mode if the data transmission is detected; and
entering the power-saving mode if the data transmission is not detected.

7. The method as claimed in claim 6, further comprising:
detecting whether a pre-determined time limit is exceeded in the sub power-saving mode, and
entering the power-saving mode if the pre-determined time limit is exceeded.

8. The method as claimed in claim 1, further comprising:
detecting a repeated movement of the electrical device; and
entering the power-saving mode when the repeated movement is detected.

9. The method as claimed in claim 1, further comprising:
determining a swaying movement based on the detected positions of the mobile phone in the power-saving mode; and
remaining in the power-saving mode when the swaying movement is detected.

10. A power-saving method for an electronic device having a display, comprising:
detecting an orientation of the electronic device through a three-dimensional accelerometer; and
activating a power-saving mode and adjusting the power consumption of the display based on the detected orientation.

11. The method as claimed in claim 10, further comprising reducing the power consumption of the display in the power-saving mode.

12. The method as claimed in claim 11, wherein said activating the power-saving mode comprises activating the power-saving mode when the detected orientation is a pre-determined orientation at which a user is inconvenient to observe the content on the display.

13. The method as claimed in claim 11, wherein said activating the power-saving mode comprises activating the power-saving mode when a pre-determined repeated movement of the mobile phone is detected.

14. The method as claimed in claim 13, further comprising determining that the repeated movement is detected when the mobile phone is repeatedly moving between a first orientation and a second orientation.

15. The method as claimed in claim 13, further comprising remaining in the power-saving mode when the repeated movement is detected.

16. The method as claimed in claim 10, further comprising remaining in the power-saving mode in response to the electronic device is locked.

17. A system for a mobile device, comprising:
a detection unit configured to detect the position of the mobile device and configured to set a plurality of pre-determined positions of the mobile device as power-saving points; and
an operational mode control unit coupled in signal communication with the detection unit, the control unit configured to receive signals representing the detected position from the detection unit and to control the mobile device to enter one of a power-saving mode and a wake-up mode based on the received signals.

18. The system as claimed in claim 17, wherein the plurality of pre-determined positions comprises at least one position at which a user is inconvenient to observe the content on a display of the mobile device.

19. The system as claimed in claim 17, wherein the plurality of pre-determined positions comprises at least one of a first position at which the mobile device is positioned substantially horizontally and a second position at which the mobile device is positioned substantially vertically.

20. The system as claimed in claim 18, wherein the control unit is configured to control the mobile phone to reduce the power consumption of the display in the power-saving mode.
